(19) United States
(12) Patent Application Publication
(10) Pub. No.: US 2013/0097243 A1
(43) Pub. Date: Apr. 18, 2013

(54) METHOD OF PROVIDING CURRENT STATE INFORMATION OF CERTAIN OFF-LINE OBJECT THROUGH NETWORK AND WEB SERVER USED THEREIN

(71) Applicant: Seung-Ki Park, Seoul (KR)

(72) Inventor: Seung-Ki Park, Seoul (KR)

(21) Appl. No.: 13/593,922

(22) Filed: Aug. 24, 2012

(30) Foreign Application Priority Data
Oct. 17, 2011 (KR) 10-2011-0105988

(51) Int. Cl. G06F 15/16

(52) U.S. Cl. 709/204

(57) ABSTRACT

Provided are a method of providing current state information of a certain off-line object through a network and a web server used therein. A web server receives a current state information request message with respect to the certain off-line object from an information provider, transmits the current state information request message to at least one information provider terminal by the web server, receives current state information of the certain off-line object from the information provider terminal, and transmits the current state information of the certain off-line object received from the information provider terminal to the information requester terminal by the web server. Users may receive concrete information of a current state with respect to a desired specific off-line object in real-time.

### CROSS-REFERENCE TO RELATED APPLICATION

This application claims under 35 U.S.C. §119(a) priority to, and the benefit of, Korean Patent Application No. 10-2011-0105988, filed on Oct. 17, 2011, the disclosure of which is incorporated herein by reference in its entirety.

### BACKGROUND OF THE INVENTION

1. Field of the Invention

The present invention relates to a method of providing current state information of a certain off-line object through a network and a web server used therein, and more particularly, it relates to a method of providing current state information of a certain off-line object through a network providing concrete information of a current state with respect to a specific off-line object in real time, and a web server used therein.

2. Description of the Related Art

With wide supply of Internet, persons may easily secure most desired information through searching in Internet space.

However, most information provided through Internet is only accumulated information for a long time period rather than information in a current state. First of all, most information provided through the Internet is only accumulated information with respect to a specific object rather than concrete information of a current state with respect to a specific off-line object.

That is, persons look back on the past while remembering specific zones, specific places, and specific spaces where the persons visited. However, if the persons do not satisfy it, the persons directly visit a corresponding zone, place, or space and confirm a current figure to remember the past.

However, significant time, cost, and endeavor are required to directly visit a corresponding space, to confirm a current state thereof, and to have satisfaction.

### SUMMARY OF THE INVENTION

The present invention has been made in view of the above problems, and provides a method of providing current state information of a certain off-line object through a network providing concrete information of a current state with respect to a specific off-line object in real time, and a web server used therein.

In accordance with an aspect of the present invention, a method of providing current state information of a certain off-line object through a network, includes: (a) receiving a current state information request message with respect to the certain off-line object by a web server an information requester terminal; (b) transmitting the current state information request message to at least one information provider terminal by the web server; (c) receiving current state information of the certain off-line object from the information provider terminal by the web server; (d) transmitting the current state information of the certain off-line object received from the information provider terminal to the information requester terminal by the web server.

The current state information may include current image information of the certain off-line object.

The information provider terminal in step (b) may be a terminal transmitting information corresponding to information included in the current state information request message to the web server.

The information included in the current state information request message may include location information of the certain off-line object.

The information included in the current state information request message may include type information of the certain off-line object.

In accordance with another aspect of the present invention, a web server includes: a receiver for receiving a current state information request message with respect to a certain off-line object from an information requester terminal; a transmitter for transmitting the current state information request message to at least one information provider terminal, wherein the receiver receives current state information of the certain off-line object from the information provider terminal, and the transmitter transmits the current state information of the certain off-line object received from the information provider terminal to the information requester terminal. The current state information may include current image information of the certain off-line object.

The information provider terminal may be a terminal transmitting information corresponding to information included in the current state information request message to the web server.

The information included in the current state information request message may include location information of the certain off-line object.

The information included in the current state information request message may include type information of the certain off-line object.

According to the present invention, users may receive concrete information of a current state with respect to a desired specific off-line object in real-time.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a configuration of a system for providing current state information of a certain off-line object through a network according to an exemplary embodiment of the present invention;

FIG. 2 is a block diagram illustrating a configuration of a web server in a system for providing current state information of a certain off-line object through a network according to an exemplary embodiment of the present invention;

FIG. 3 is a signal flowchart illustrating an operation principle of a system for providing current state information of a certain off-line object through a network according to an exemplary embodiment of the present invention; and

FIGS. 4 and 5 are diagrams illustrating a current state information request message and current state information provided thereto in a method for providing current state information of a certain off-line object through a network according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

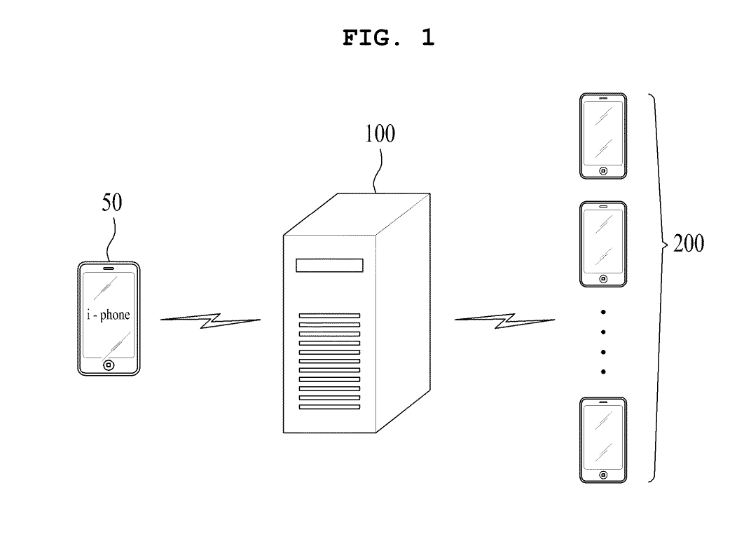

FIG. 1 is a diagram illustrating a configuration of a system for providing current state information of a certain off-line object through a network according to an exemplary embodiment of the present invention. Referring to FIG. 1, a system for providing current state information of a certain off-line object through a network includes an information requester terminal 50, a web server 100, and at least one information provider terminal 200.

First, an information requester transmits a current state information request message requesting current state information such as a shape of a current time point with respect to a certain object, a product specification, an outer appearance of a product to be confirmed by himself/herself, using the information requester terminal 50 such as a smart phone to the web server 100.

Accordingly, the web server 100 receives and stores the current state information request message from the information requester terminal 50. Further, the web server 100 selects an information provider terminal 200 having transmitted information corresponding to the information included in a current state information request message to the web server 100 from a plurality of information provider terminals 200, and transmits the current state information request message received from the information requester terminal 50 to the information provider terminals 200.

Meanwhile, a current state information provider of a certain object using the information provider terminal 200 receives a current state information request message with respect to a certain object through the information provider terminal 200, and acquires current state information with respect to the certain object and transmits the acquired current state information to the information requester terminal 50 through the web server 100.

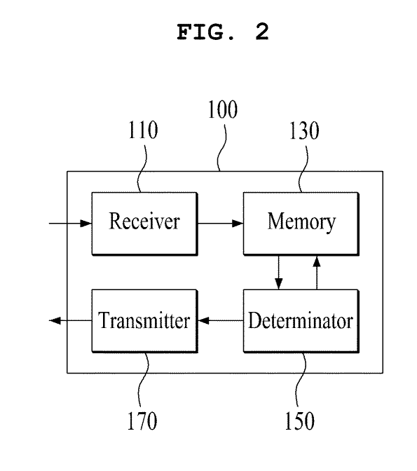

FIG. 2 is a block diagram illustrating a configuration of a web server in a system for providing current state information of a certain off-line object through a network according to an exemplary embodiment of the present invention. Referring to FIG. 2, the web server 100 in a system for providing current state information of a certain off-line object through a network according to an exemplary embodiment of the present invention includes a receiver 110, a memory 130, a determinator 150, and a transmitter 170.

First, the receiver 110 of the web server 100 receives a current state information request message with respect to a certain off-line object from the information requester terminal 50, and receives key word information displaying a certain object about which an information provider may provide information from the information provider terminal 200, and receives current state information with respect to the certain object from the information provider terminal 200.

The memory 130 stores a current state information request message with respect to a certain object from the information requester terminal 50, current state information of the certain object from the information provider terminal 200, and key word information received from the information provider terminal 200.

The determinator 150 of the web server 100 searches key word information corresponding to information included in a current state information request message received from a search requester terminal from the memory 130, and determines the information provider terminal 200 having provided the corresponding key word information as a terminal to which a current state information request message will be transmitted.

Further, the transmitter 170 of the web server 100 transmits the current state information request message stored in the memory 130 to the information provider terminal 200 which the determinator 150 has determined, and transmits current state information with respect to the certain object received from the information provider terminal 200 to a searcher terminal.

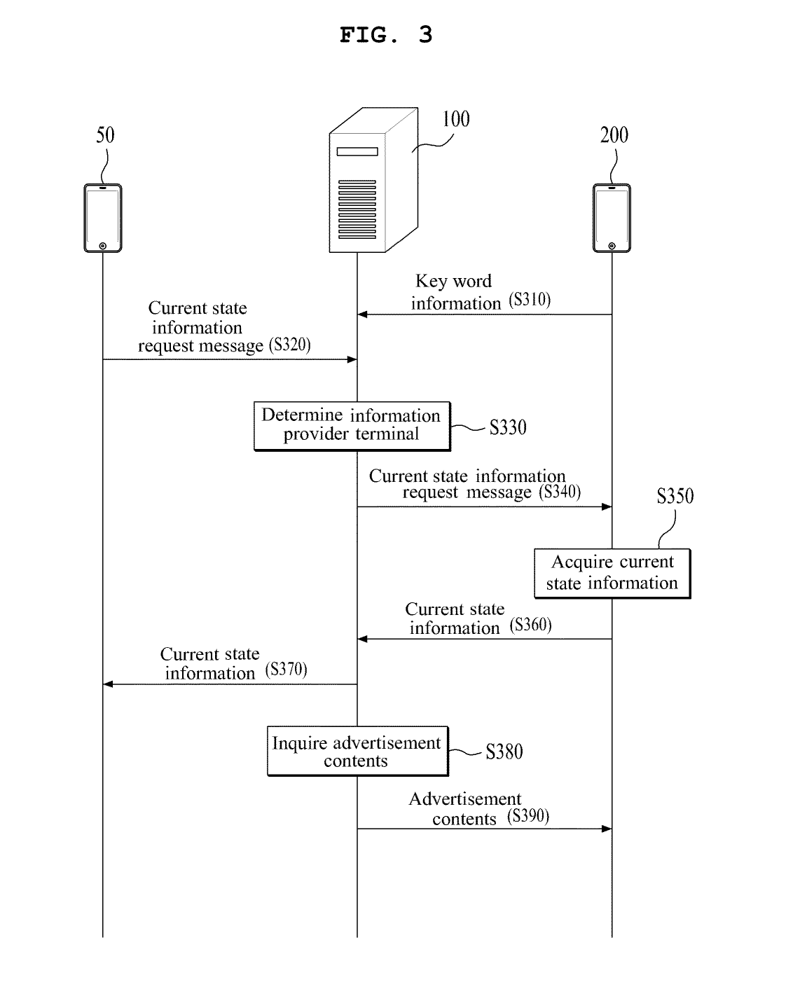

FIG. 3 is a signal flowchart illustrating an operation principle of a system for providing current state information of a certain off-line object through a network according to an exemplary embodiment of the present invention. The operation principle of a system for providing current state information of a certain off-line object through a network according to an exemplary embodiment of the present invention will be described with reference to FIGS. 1 to 3.

First, a receiver 110 of a web server 100 receives key word information displaying a certain object about which an information provider can provide information from each information provider terminal 200 used by each information provider (S310), and stores the key word information in a memory 130 of the web server 100.

In an embodiment of the present invention, when a certain object is a certain zone or place, the key word may be a zone name (e.g., Miami beach, Jeju island beach, Cheonho-dong, Kaepo-dong, etc.) or place name (e.g., Seoul tower, ∘∘ restaurant, oo restaurant toilet, etc.). When the certain object is a product, the key word may be a product name (e.g., i-phone, i-pad, inavi navigation device, etc.).

Meanwhile, in the embodiment of the present invention, an information provider does not directly input and transmit key word information using his/her own terminal, but an information provider terminal 200 may automatically transmit location information of a corresponding zone or place to a web server 100 as key word information on the assumption of agreement with respect to location information provision from an information provider.

Next, an information requester transmits a current state information request message requesting current state information such as a shape of a current time point with respect to a certain object, product specification, a shape of a product using an information requester terminal 50 such as a smart phone which the information requester has.

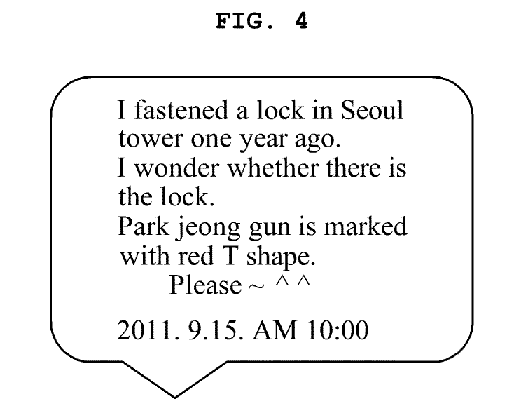

Concretely, to know a current state of a lock which the information requester visited in Seoul tower and fastened, the information requester may transmit a current state information request message of a certain object in the form of a character message as illustrated in FIG. 4.

In the embodiment of the present invention, the current state information request message of a certain object which the information requester transmits may include “want to see how shows a stage in No. 3 seat of row A in theater ∘∘”, “want to see a shape of Miami beach”, “want to see internal side of elevator in Eiffel tower”, “want to see toilet shape in ∘∘ restaurant”, “want to see how changed a shape of Kaepo-dong lived twenty years ago”, “want to see a battery bottom of IBM notebook”. Accordingly, the information requester may request current state information with respect to various types of desired objects.

The receiver 110 of the web server 100 receives a current state information request message from the information requester terminal 50 and stores it in the memory 130 of the web server 100, and then the determinator 150 of the web server 100 inquires an information provider terminal 200 providing current state information of a corresponding certain object based on information included in the stored current state information request message (S330).

Concretely, a determinator 150 of the web server 100 searches key word information corresponding to at least one of information included in the current state information request message from the memory 130. When the current state information request message is a current state information request message shown in FIG. 4, the determinator 150 searches key word information corresponding to information such as “Seoul tower”, or “lock”.

Meanwhile, in step S310, an information provider visiting in Seoul tower transmits “Seoul tower” as key word information displaying a certain object about which the information provider can provide information to the web server 100 to inform that the information provider can provide information regarding Seoul tower. The key word information is stored in the memory 130 of the web server 100 together with ID of a corresponding information provider terminal 200.

Accordingly, the determinator 150 of the web server 100 searches “Seoul tower” as a key word information in memory 130 and determines an information provider terminal 200 having transmitted “Seoul tower” as key word information as a terminal to which a current state information request message in FIG. 4 including “Seoul tower” will be transmitted (S330).

Meanwhile, in the embodiment of the present invention, the memory 130 of the web server 100 preferably stores ID of the information requester terminal 50, a current state information request message, and ID of the information provider terminal 200 determined in step S330.

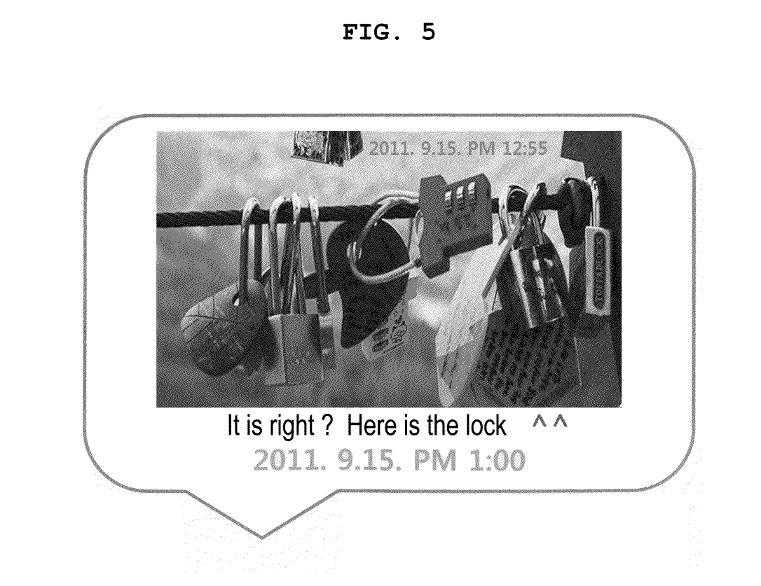

After that, the transmitter 170 of the web server 100 transmits a current state information request message as illustrated in FIG. 4 to the information provider terminal 200 determined in step S330 (S340). An information provider having confirmed a current state information request message through its terminal photographs a corresponding lock in Seoul tower where the information provider is currently located to acquire current state information (S350). The information provider transmits a photographed image to the web server 100 as current state information with respect to a certain object as illustrated in FIG. 5 (S360).

In the meantime, in the embodiment of the present invention, the information provider terminal 200 may add additional information such as comment information of the information provider as illustrated in FIG. 5 when the information provider terminal 200 transmits current state information.

Meanwhile, after receiving current state information with respect to a certain object from the information provider terminal 200, the receiver 100 of the web server 100 transmits the received current state information to the information requester terminal 50 having requested a corresponding state information (S370).

In the embodiment of the present invention, the memory 130 of the web server 100 may store advertisement contents provided on a network by certain zones or places. In this case, the determinator 150 of the web server 100 may determine an information provider terminal 200 having transmitted a zone (or place) corresponding to a certain zone (or place) associated with certain advertisement contents of information provider terminals 200 having transmitted zone name or place name to the web server as key word information in step S310 as a terminal to which advertisement contents will be transmitted.

Concretely, if a businessman of Lotte world manufactures advertisement contents for advertizing products or events provided to customers visited in Lotte world from Lotte world, and transmits the manufactured advertisement contents to the web server 100, the memory 130 of the web server 100 stores the manufactured advertisement contents. Here, “Lotte world” should be stored in corresponding advertisement contents as relation zone information.

In the meantime, an information provider visiting in Lotte world transmits “Lotte world” to the web server 100 using its terminal as key word information, and the “Lotte world” is stored in the memory 130 of the web server 100. In this case, the determinator 150 of the web server 100 determines a corresponding information provider terminal 200 as a terminal to which advertisement contents stored associated with “Lotte world”, will be transmitted and transmits advertisement contents for advertizing products or events in Lotte world to a corresponding information provider terminal 200.

However, when an information provider does not want to transmit advertisement contents to its terminal, the information provider may transmit an advertisement reception rejection message which does not want reception in advertisement content to the web server 100. In this case, it is preferable that the advertisement contents are not transmitted. In a case of public advertisement contents warning emergency situation such as a flood or a typhoon, the advertisement contents are preferably transmitted to a terminal of an information provider regardless of advertisement reception rejection intent.

Although exemplary embodiments of the present invention have been described in detail hereinabove, it should be clearly understood that many variations and modifications of the basic inventive concepts herein taught which may appear to those skilled in the current art will still fall within the spirit and scope of the present invention, as defined in the appended claims.

What is claimed is:

1. A method of providing current state information of a certain off-line object through a network, comprising:
(a) receiving a current state information request message with respect to the certain off-line object from an information provider by a web server;
(b) transmitting the current state information request message to at least one information provider terminal by the web server;
(c) receiving current state information of the certain off-line object from the information provider terminal by the web server;
(d) transmitting the current state information of the certain off-line object received from the information provider terminal to the information requester terminal by the web server.

2. The method of claim 1, wherein the current state information includes current image information of the certain off-line object.

3. The method of claim 1, wherein the information provider terminal in step (b) is a terminal transmitting information corresponding to information included in the current state information request message to the web server.

4. The method of claim 3, wherein the information included in the current state information request message includes location information of the certain off-line object.

5. The method of claim 3, wherein the information included in the current state information request message includes type information of the certain off-line object.

6. A web server comprising:
a receiver for receiving a current state information request message with respect to a certain off-line object from an information provider;
a transmitter for transmitting the current state information request message to at least one information provider terminal,
wherein the receiver receives current state information of the certain off-line object from the information provider terminal, and the transmitter transmits the current state information of the certain off-line object received from the information provider terminal to the information requester terminal.

7. The web server of claim 6, wherein the current state information includes current image information of the certain off-line object.

8. The web server of claim 6, wherein the information provider terminal is a terminal transmitting information corresponding to information included in the current state information request message to the web server.

9. The web server of claim 8, wherein the information included in the current state information request message includes location information of the certain off-line object.

10. The web server of claim 8, wherein the information included in the current state information request message includes type information of the certain off-line object.
